(19) United States
(12) Patent Application Publication
(10) Pub. No.: US 2020/0202816 A1
(43) Pub. Date: Jun. 25, 2020

(54) DISPLAY DEVICE AND DRIVING METHOD THEREOF

(71) Applicant: Samsung Display Co., Ltd., Yongin-si (KR)

(72) Inventors: Dong In KIM, Yongin-si (KR); Jun Dal KIM, Yongin-si (KR)

(21) Appl. No.: 16/549,121

(22) Filed: Aug. 23, 2019

(30) Foreign Application Priority Data
Dec. 20, 2018 (KR) 10-2018-0166384

(51) Int. Cl. G09G 5/18; G09G 3/36; G09G 3/34; G06F 3/14

(52) U.S. Cl. CPC G09G 5/18; G06F 3/14; G09G 3/3406; G09G 3/3611

(57) ABSTRACT

A display device includes a display panel, a timing controller for detecting a frame frequency of input data, for generating a control signal based on the frame frequency, and for generating frame data by converting the input data, and a source drive for variably amplifying the frame data based on the control signal, for generating a data signal based on the amplified frame data, and for providing the data signal to the display panel.

### CROSS-REFERENCE TO RELATED APPLICATION

This application claims priority to, and the benefit of, Korean Patent Application No. 10-2018-0166384 filed in the Korean Intellectual Property Office on Dec. 20, 2018, the entire contents of which are incorporated herein by reference.

### BACKGROUND

### 1. Field

The present disclosure relates to a display device, and a driving method thereof.

### 2. Description of the Related Art

A display device, such as a liquid crystal display or an organic light emitting diode display, transmits various data suitable for generating a data signal through an intra-panel interface formed between a timing controller (TCON) and a source drive integrated circuit (source drive IC, or S-IC).

The timing controller supplies a data control signal and frame data to the source drive IC. The source drive IC generates a data signal in response to the data control signal and the frame data, and outputs the data signal to data lines of a display panel.

Recently, a display device has been developed that drives with a variable refresh rate (or variable frame rate/frame frequency) to display images more accurately, or to reduce load and power consumption.

### SUMMARY

When a data rate of an intra-panel interface between a timing controller and a source drive IC increases on the basis of the maximum frame frequency that is supported by a display device, signal distortion (or signal loss) is intensified, and signal integrity of frame data is deteriorated.

To improve the deterioration of the signal integrity, a recovery circuit for recovering the distorted signal is provided in the display device. However, the recovery circuit operates on the basis of the maximum frame frequency as a reference, thereby increasing the power consumption of the display device.

An embodiment of the present disclosure provides a display device that can reduce power consumption while maintaining signal integrity and a driving method thereof.

A display device according to an embodiment of the present disclosure includes a display panel, a timing controller for detecting a frame frequency of input data, for generating a control signal based on the frame frequency, and for generating frame data by converting the input data, and a source drive for variably amplifying the frame data based on the control signal, for generating a data signal based on the amplified frame data, and for providing the data signal to the display panel.

The source drive may include an equalizer for flattening a frequency response of the frame data, an input buffer for removing a noise signal from the amplified frame data, and a video signal processor for generating the data signal based on an output of the input buffer, wherein the source drive is configured to vary at least one of a gain of the equalizer and a bias current of the input buffer based on the control signal.

The source drive may further include a controller for extracting the control signal from the output of the input buffer, and for generating a gain control signal and a bias control signal based on the control signal, wherein the equalizer is configured to control the gain in response to the gain control signal, and wherein the input buffer is configured to adjust the bias current in response to the bias control signal.

The gain may be configured to increase incrementally as the frame frequency increases.

The equalizer may include a main-output node and a sub-output node for outputting the amplified frame data, a capacitor connected between the main-output node and the sub-output node, and a resistor connected in parallel with the capacitor, wherein at least one of capacitance the capacitor and resistance of the resistor varies in response to the control signal.

The bias current may be configured to increase incrementally as the frame frequency increases.

The input buffer may include a first switch that is connected between a first power source voltage and a first node, and is configured to adjust the bias current flowing from the first power source voltage to the first node in response to the control signal, a second switch that is connected between the first node and a second power source voltage, and that is configured to operate in response to a sub-output signal output from the equalizer, and a third switch that is connected between the first node and a output terminal, and that is configured to operate in response to a main-output signal output from the equalizer.

The timing controller may include a frequency detector for detecting the frame frequency from the input data, a first controller for generating the control signal by selecting one of setting values based on the frame frequency, a video signal processor for generating the frame data by rearranging the input data, and a transmitter for transmitting the control signal and the frame data to the source drive.

The display device may further include a memory device for storing the setting values in a form of a lookup table.

The display device may further include channel lines connecting the timing controller and the source drive, wherein the control signal and the input data are sequentially provided from the timing controller to the source drive through the channel lines.

The display device may further include channel lines and a common control line connecting the timing controller and the source drive, wherein the common control line is connected in common with other source drives, wherein the timing controller is configured to transmit the control signal to the source drive through the common control line, and wherein the timing controller is configured to transmit the frame data to the source drive through the channel lines.

The source drive may include an equalizer for flattening a frequency response of the input data, an input buffer for removing a noise signal from the amplified frame data, a video signal processor for generating the data signal based on an output of the input buffer, and a controller for receiving the control signal directly from the timing controller, and for generating a gain control signal and a bias control signal based on the control signal, wherein the equalizer is configured to control a gain in response to the gain control signal, and wherein the input buffer is configured to adjust a bias current of the input buffer in response to the bias control signal.

A driving method of a display device according to an embodiments of the present disclosure includes generating a control signal by detecting a frame frequency of input data in a timing controller, generating frame data by converting the input data in the timing controller, variably amplifying the frame data based on the control signal in a source drive, and generating a data signal based on the amplified frame data to provide the data signal to a display panel.

The variably amplifying the frame data may include adjusting a frequency response of the frame data by varying a gain of an equalizer in a receiving stage of the source drive in response to the control signal.

The variably amplifying the frame data may further include adjusting a bias current applied to an input buffer in the receiving stage of the source drive in response to the control signal.

A display device according to an embodiment of the present disclosure a driving method thereof may detect the frame frequency from the input data provided from the external (e.g., a graphic card), and may vary at least one of the gain of the equalizer of the source drive IC (e.g., a receiving stage of an intra-panel interface between the timing controller and the source drive IC) and the bias current of the differential amplifier according to the detected frame frequency. Therefore, signal integrity may be maintained, and power consumption may be reduced.

### BRIEF DESCRIPTION OF THE DRAWINGS

FIG. 1 illustrates a display device according to an embodiment of the present disclosure.

FIG. 2 illustrates an example of a signal transmission line connecting a timing controller and a source drive IC included in a display device of FIG. 1.

FIG. 3 a block diagram illustrating an example of a timing controller and a source drive IC included in a display device of FIG. 1.

FIG. 4 is a circuit diagram illustrating an example of a source drive IC of FIG. 3.

FIG. 5 illustrates an example of a frequency response characteristic of a source drive IC of FIG. 4.

FIG. 6 illustrates another example of a signal transmission line connecting a timing controller and a source drive IC included in a display device of FIG. 1.

FIG. 7 is a block diagram illustrating another example of a timing controller and a source drive IC included in a display device of FIG. 1.

FIG. 8 is a block diagram illustrating another example of a timing controller and a source drive IC included in a display device of FIG. 1.

FIG. 9 is a flowchart illustrating a driving method of a display device according to an embodiment of the present disclosure.

### DETAILED DESCRIPTION

Features of the inventive concept and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects and features of the present inventive concept to those skilled in the art. Accordingly, processes, elements, and techniques that are not necessary to those having ordinary skill in the art for a complete understanding of the aspects and features of the present inventive concept may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting. Additionally, as those skilled in the art would realize, the described embodiments may be modified in various different ways, all without departing from the spirit or scope of the present disclosure.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” when preceding a list of elements, modify the entire list of elements and do not modify the individual elements of the list. For example, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When a certain embodiment may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

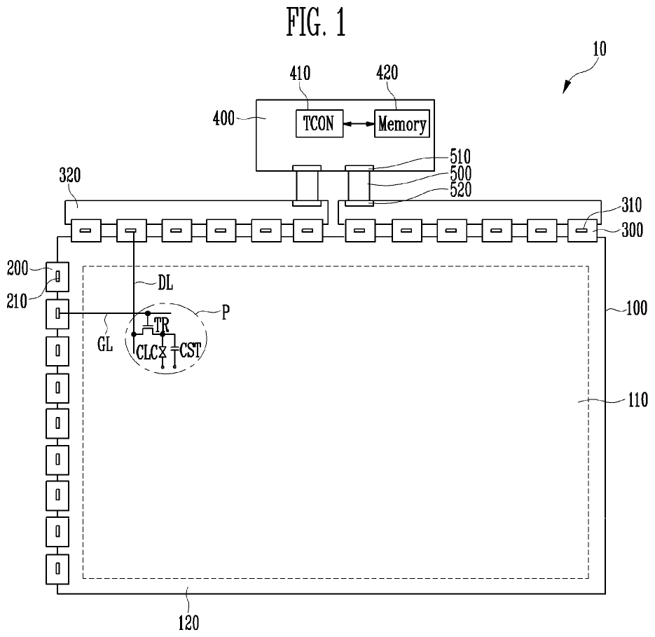

FIG. 1 illustrates a display device according to an embodiment of the present disclosure. FIG. 1 shows a liquid crystal display having a plurality of gate drive ICs and source drive ICs as an embodiment to which the present disclosure may be applied. The present disclosure, however, is not limited thereto. For example, the present disclosure may be also applied to a display device having one gate drive IC and one source drive IC. In addition, the present disclosure is not limited to a liquid crystal display, and the present disclosure may be applied to other types of display device, such as an organic light emitting diode display.

Referring to FIG. 1, a display device 10 includes a display panel 100, a gate drive IC 210, a source drive IC 310, and a timing controller 410. In addition, the display device 10 may further include a memory device 420 and a cable (or a flexible circuit substrate) 500.

The display panel 100 may include a display region 110 for displaying an image, and a non-display region 120 outside of the display region 110. The display panel 100 may include a gate line GL, a data line DL, and a pixel P. The pixel P may be located in a region partitioned by, or corresponding to, the gate line GL and the data line DL.

The pixel P may include a switch TR, a liquid crystal capacitor CLC, and a storage capacitor CST. The switch TR may be electrically connected to the gate line GL and to the data line DL in a region in which the pixel P is located. The liquid crystal capacitor CLC may be connected to the switch TR, and the storage capacitor CST may be connected to the liquid crystal capacitor CLC. The pixel P may receive a data signal through the data line DL in response to a gate signal provided through the gate line GL. The pixel P stores the data signal in the storage capacitor CST, and controls an amount of light that is emitted from a backlight corresponding to the data signal, thereby displaying luminance corresponding to the data signal.

A timing controller 410 may control a gate drive IC 210 and a source drive IC 310. The timing controller 410 may receive an externally supplied control signal (e.g., a control signal including a clock signal), and may generate a gate control signal and a data control signal based on the control signal. The timing controller 410 may provide the gate control signal to the gate drive IC 210, and may provide the data control signal to the source drive IC 310.

In addition, the timing controller 410 may generate frame data by rearranging externally provided input data (or raw image data) (e.g., provided from a graphic processor), and may provide the frame data to the source drive IC 310. The timing controller 410 may transmit the frame data in a packet form to the source drive IC 310 by using a serial interface (or high speed serial interface). The timing controller 410 may be mounted on a control board 400.

In an embodiment, the timing controller 410 may detect the frame frequency based on the input data, and may generate a compensation control signal corresponding to the frame frequency. Here, the frame frequency is a refresh rate of the frame data, which indicates the number of the frame data per second, and may be variable according to the input data.

The compensation control signal may be provided to the source drive IC 310, and may be used to adjust (or vary) a signal compensation capability (or an ability to recover a distorted signal, for example, a compensation gain of a high frequency component) of the source drive IC 310. Meanwhile, the compensation control signal may be included in the data control signal, or may be provided to the source drive IC 310 separately from the data control signal.

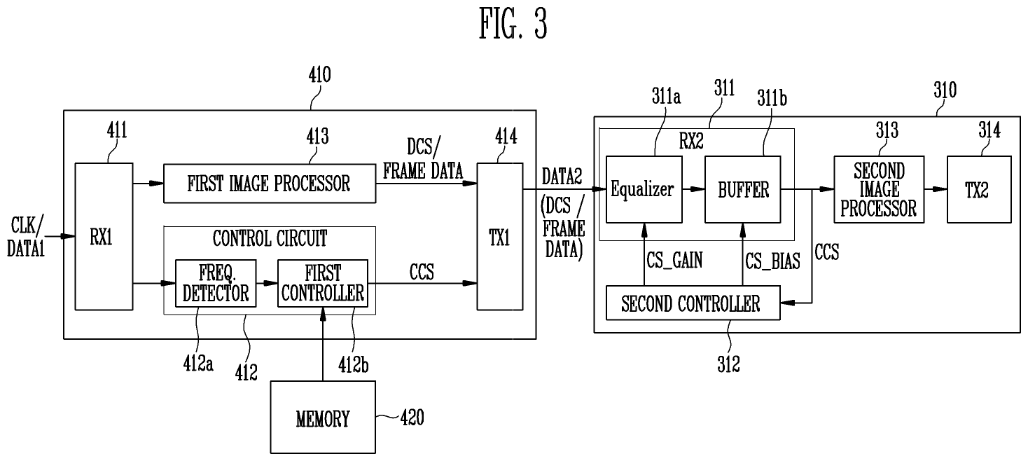

An example of a configuration and operation of the timing controller 410 will be described later with reference to FIG. 3.

The gate drive IC 210 and the source drive IC 310 may drive the display panel 100.

The gate drive IC 210 (which may also be referred to as a gate driver and/or a scan driver) may receive the gate control signal from the timing controller 410, and may generate gate signals based on the gate control signal. The gate drive IC 210 may provide a gate signal to the gate line GL.

The gate drive IC 210 may be mounted on the gate drive circuit film 200, and may be connected to the timing controller 410 mounted on the control board 400 via at least one of a source drive circuit film 300, a source printed circuit substrate 320, and/or a cable (or a flexible circuit substrate) 500. However, the present disclosure is not limited thereto. For example, the gate drive IC 210 may be formed with the pixel P on the display panel 100.

The source drive IC 310 (which may be referred to as a source driver and/or a data driver) may receive a data control signal and frame data from the timing controller 410, and may generate a data signal corresponding to frame data. The source drive IC 310 may provide the data signal to the data line (DL). The source drive IC 310 may be mounted on a source drive circuit film 300, and may be connected to the timing controller 410 via at least one source printed circuit substrate 320 and/or cable 500.

In an embodiment, the source drive IC 310 may adjust or vary the signal compensation capability based on the compensation control signal while compensating for distortion of the frame data. Here, the compensation control signal may be provided from the timing controller 410.

For example, the source drive IC 310 may relatively increase the signal compensation capability (e.g., a compensation gain of a high frequency component) when the frame frequency is relatively high. In this case, signal integrity may be maintained.

In another embodiment, the source drive IC 310 may relatively decrease the signal compensation capability when the frame frequency is relatively low. In this case, the power consumption of the source drive IC 310 (and display device 10) may be reduced.

An example of a configuration and operation of the source drive IC 310 will be described later with reference to FIG. 3.

The memory device 420 may be mounted on the control board 400. The memory device 420 may be a non-volatile memory (NVRAM). The memory device 420 may store data that is suitable for an operation of the timing controller 410 (e.g., a driving setting value of the display device 10, a grayscale compensation value for pixel-by-pixel luminance compensation, etc.). In addition, the memory device 420 may further include a look-up table (LUT) showing a correlation between the frame frequency and the compensation control signal.

The cable 500 may electrically connect a control board 400 to at least one source printed circuit substrate 320 through upper and lower connectors 510 and 520. Here, the term “cable” comprehensively refers to a device having a line which may electrically connect a control board 400 to a source printed circuit substrate 320, or the like. For example, the cable 500 may be implemented as a flexible circuit substrate.

As described with reference to FIG. 1, the display device 10 may detect the frame frequency based on the input data, and may vary the signal compensation capability (e.g., may vary the ability to recover the distortion of the frame data) of the source drive IC according to the frame frequency, thereby maintaining signal integrity and reducing power consumption.

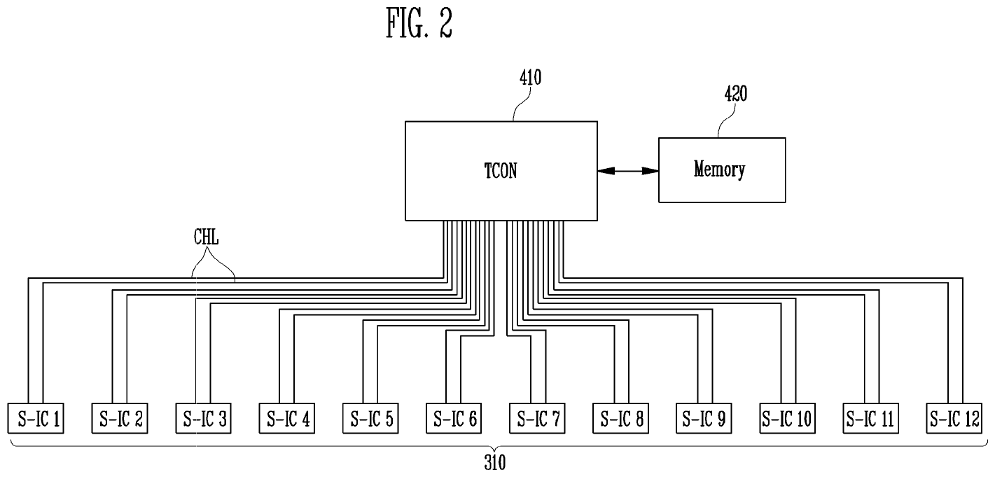

FIG. 2 illustrates an example of a signal transmission line connecting a timing controller and a source drive IC included in a display device of FIG. 1.

FIG. 2 illustrates twelve source drive ICs, that is, first to twelfth source drive ICs S-IC 1 to S-IC 12. Each of the first to twelfth source drive ICs S-IC 1 to S-IC 12 may be configured to be substantially the same. Each of the first to twelfth source drive ICs S-IC 1 to S-IC 12 may be connected to the data line of an assigned region of data lines formed in the display panel 100, and may provide a data signal to a corresponding data line.

Referring to FIG. 2, channel lines CHL are formed between the source drive ICs 310 and the timing controller 410. The channel line CHL may be included in the signal transmission line described with reference to FIG. 1.

The channel line CHL may be formed between the timing controller 410 and each source drive IC 310. In FIG. 2, a pair of channel lines CHL are formed between each respective source drive IC 310 and the timing controller 410. However, the present disclosure is not limited thereto, and the number of the channel line CHL formed between each source drive IC 310 and the timing controller 410 may be variously changed.

The channel line CHL may be used to transmit the data control signal DCS and the frame data for driving the source drive IC 310 from the timing controller 410 to each source drive IC 310.

FIG. 3 a block diagram illustrating an example of a timing controller and a source drive IC included in a display device of FIG. 1.

Referring to FIG. 3, the timing controller 410 may include a first receiver 411, a control circuit 412, a first video signal processor/image processor 413, and a first transmitter 414.

The first receiver 411 may receive input data DATA1 and a control signal (e.g., a control signal such as the clock signal CLK), which may be externally supplied. For example, the first receiver 411 may form one interface system with a transmitter of a graphic processor, and may include a receiving circuit corresponding to the transmitter of the graphic processor.

The control circuit 412 may detect the frame frequency based on the input data DATA1, and may generate a compensation control signal CCS corresponding to the frame frequency.

In an embodiment, the control circuit 412 may include a frequency detector 412a and a first controller 412b.

The frequency detector 412a may calculate the frame frequency based on a transmission period of the input data DATA1, or may extract frame frequency information assigned to a given position of the input data DATA1.

The first controller 412b may generate the compensation control signal CCS based on the frame frequency detected in the frequency detector 412a.

In an embodiment, the first controller 412b may generate the compensation control signal CCS corresponding to the frame frequency using a lookup table. Here, the lookup table may include setting values of a compensation control signal (e.g., a predetermined compensation control signal) CCS for each frame frequency or for each frame frequency section. The lookup table may be stored in the memory device 420, and may be updated.

TABLE 1

| | Buffer-bias-current-setting | Equalizer-gain-setting |
|---|---|---|
| Frame frequency | value | value |
| Under 80 Hz | 00 | 00 |
| 80 Hz-140 Hz | 01 | 01 |
| 140 Hz-200 Hz | 10 | 10 |
| Above 200 Hz | 11 | 11 |

Table 1 shows an example of a lookup table.

Referring to Table 1, the frame frequency may be divided into four sections corresponding to the frequencies of 80 Hz, 140 Hz, and 200 Hz, and may include a buffer-bias-current-setting value and an equalizer-gain-setting value set for each of frame frequency sections. Here, the buffer-bias-current-setting value may be a value for controlling a bias current used in an input buffer 311b included in a second receiver 311 of a source drive IC 310 to be described later, and the equalizer-gain-setting value may be a value for controlling a gain of an equalizer 311a included in the second received 311, as will be described later.

For example, when the frame frequency is 60 Hz, the first controller 412b may generate a first control signal that includes a first buffer-bias-current-setting value of 00 and a first equalizer-gain-setting value of 00. For another example, when the frame frequency is 120 Hz, the first controller 412b may generate a second control signal that includes a second buffer-bias-current-setting value of 01 and a second equalizer-gain-setting value of 01.

Table 1 is an illustrative example, and the lookup table is not limited thereto. For example, the lookup table may also include a buffer-bias-current-setting value and an equalizer-gain-setting value set corresponding to five or more frame frequency sections.

In an embodiment, the first controller 412b may generate the compensation control signal CCS by comparing the frame frequency with reference values (e.g., predetermined reference values), and may be implemented as a logic circuit. For example, the first controller 412b may compare the frame frequency with reference frame frequencies (e.g., 80 Hz, 140 Hz, and 200 Hz), and may generate the compensation control signal CCS by logically computing the compared results. In this case, a degree of freedom in setting a setting value of the compensation control signal CCS is somewhat lowered, but a cost for the memory device 420 for storing the look-up table of Table 1 may be reduced.

The compensation control signal CCS generated in the first controller 412b may be provided to the first transmitter 414.

The first video signal processor 413 may receive the input data DATA1 and control signals (e.g., control signals including clock signals CLK) from the first receiver 411. The first video signal processor 413 may rearrange the input data DATA1 in response to a control signal such as the clock signal CLK. For example, the first video signal processor 413 may be configured to include a serializer.

The first video signal processor 413 may generate a data control signal DCS in response to the control signal. The data control signal DCS may be configured in the form of a packet including information that is suitable for an initialization operation in the source drive IC 310, for example, a clock training pattern or the like. In addition, the data control signal DCS may also include a compensation control signal CCS.

The first transmitter 414 may send the data control signal DCS to the source drive IC 310, and may transmit the rearranged input data to the source drive IC 310 as frame data FRAME DATA. The data control signal DCS and that frame data FRAME DATA may be transmitted as one packet data DATA2.

The source drive IC 310 may include a second receiver 311, a second controller 312, a second video signal processor/image processor 313, and a second transmitter 314.

The second receiver 311 may receive the packet data DATA2 from the timing controller 410, may transfer the data control signal DCS included in the packet data DATA2 to the second controller 312, and may transmit the frame data FRAME DATA to the second video signal processor 313.

The second receiver 311 may include an equalizer 311a and an input buffer 311b.

The equalizer 311a may flatten the frame frequency response. That is, the equalizer 311a may compensate for signal distortion (e.g., distortion of high-frequency components) in the transmission process between the timing controller 410 and the source drive IC 310. The input buffer 311b may remove noises (or noise signals) included in the frame data equalized in the equalizer 311a.

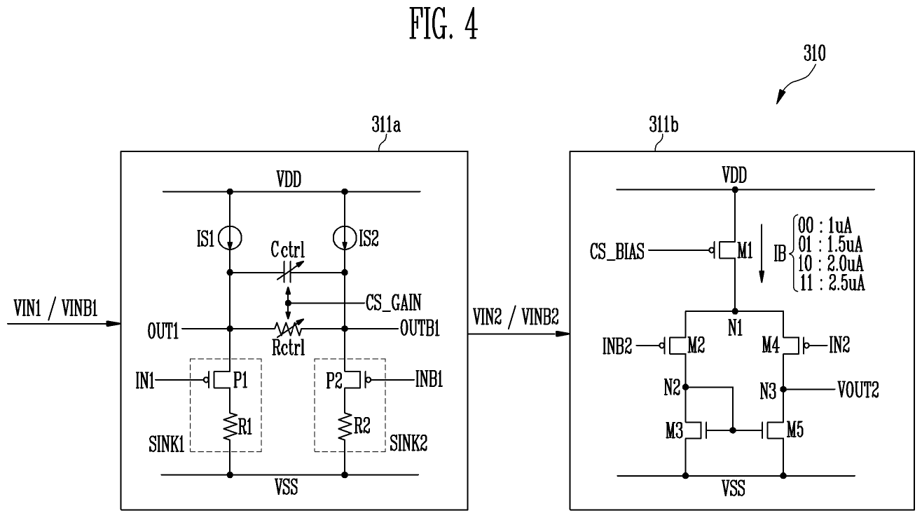

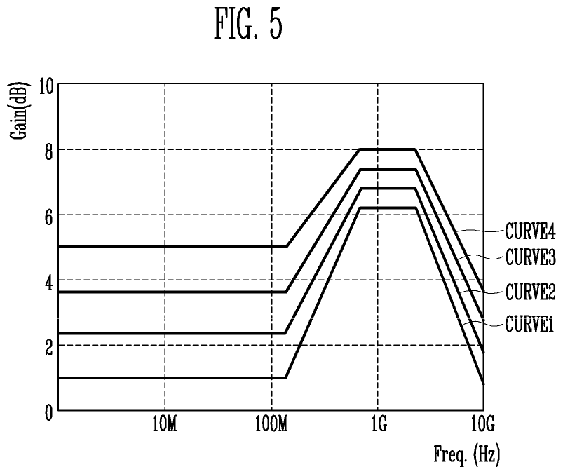

An example of a configuration and operation of the equalizer 311a and input buffer 311b will be described with reference to FIGS. 4 and 5.

FIG. 4 is a circuit diagram illustrating an example of a source drive IC of FIG. 3. FIG. 5 illustrates an example of a frequency response characteristic of a source drive IC of FIG. 4. FIG. 4 also illustrates a circuit of the equalizer 311a and the input buffer 311b included in the source drive IC 310, and FIG. 5 also illustrates frequency response characteristics of the equalizer 311a.

Referring to FIG. 4, the equalizer 311a may include a first current source IS1, a second current source IS2, a first sinking unit SINK1, a second sinking unit SINK2, a capacitor Cctrl, and a resistor Rctrl.

The first current source IS1 may supply a certain amount of current to a main-output node OUT1. The second current source IS2 may supply the same amount of current as the first current source IS1 to a sub-output node OUTB1.

The first sinking unit SINK1 may sink the current of the main-output node OUT1 in response to a voltage level of a first main-input node IN1. The second sinking unit SINK2 may sink the current of the sub-output node OUTB1 in response to a voltage level of a sub-input node INB1.

The first sinking unit SINK1 may include a first transistor P1 and a first resistor R1 connected in series between the main-output node OUT1 and a second power source voltage VSS. Similarly, the second sinking unit SINK2 may include a second transistor P2 and a second resistor R2 connected in series between the sub-output node OUTB1 and the second power source voltage VSS.

The first main-input node IN1 may receive main data VIN1, and the sub-input node INB1 may receive sub data VINB1. Equalized data, which is the output of the equalizer 311a, may be output to the main-output node OUT1, and data having an opposite phase to the equalized data may be output to the sub-output node OUTB1.

The signal of the first main-input node IN1 and the signal of the sub-input node INB1 may be output to the main-output node OUT1 and the sub-output node OUTB1.

The capacitor Cctrl and the resistor Rctrl may be connected between the main-output node OUT1 and the sub-output node OUTB1. Here, the capacitor Cctrl may be a variable capacitor capable of adjusting capacitance, and the resistor Rctrl may be a variable resistor capable of adjusting resistance.

The frequency response characteristic, that is, the gain of the equalizer 311a, may be adjusted according to the capacitance of the capacitor Cctrl and the resistance of the resistor Rctrl. For example, as the capacitance of the capacitor Cctrl increases, the gain at the high frequency may increase. For another example, as the resistance of the resistor Rctrl increases, the gain at low frequency may increase.

The equalizer 311a may adjust at least one of the capacitance of the capacitor Cctrl and the resistance of the resistor Rctrl according to a gain control signal CS_GAIN. Here, the gain control signal CS_GAIN may be generated in the second controller 312 based on the equalizer-gain-setting value included in the compensation control signal CCS (see FIG. 3).

Referring to FIG. 5, first to fourth curves CURVE1 to CURVE4 represent frequency response curves (or frequency gain curves) corresponding to the equalizer-gain-setting values of Table 1, respectively.

Attenuation of the high frequency component of the frame data transmitted through the signal transmission line may be larger than attenuation of the low frequency signal. Therefore, in the frequency response curves, a gain at a high frequency band (e.g., several GHz or more) may be larger than a gain at a low frequency band (e.g., 100 MHz or less).

The equalizer 311a increases the capacitance of the capacitor Cctrl and the resistance of the resistor Rctrl as the frame frequency increases, thereby increasing the gain for the high frequency signal.

Referring to FIG. 4, the input buffer 311b may remove the noise included in the frame data equalized in the equalizer 311a. FIG. 4 schematically illustrates a previous circuit diagram of the differential amplifier type input buffer.

The input buffer 311b may be connected between a first power source voltage VDD and the second power source voltage VSS, may remove a common phase mode of a main-input signal VIN2 and a sub-input signal VINB2, and may amplify the difference between the main-input signal VIN2 and the sub-input signal VINB2 to output a output signal VOUT2. Here, the main-input signal VIN2 and the sub-input signal VINB2 may correspond to main-data equalized by the equalizer 311a and data having an opposite phase thereto, respectively.

The input buffer 311b may include first to fifth switches M1 to M5. The first, second, and fourth switches M1, M2, and M4 may be implemented as P-type transistors, and the third and fifth switches M3 and M5 may be implemented as N-type transistors.

The first switch M1 may be connected between the first power source voltage VDD and a first node N1, and MAY adjust the bias current of the input buffer 311b in response to a bias current control signal CS_BIAS. Here, the bias current control signal CS_BIAS may correspond to the buffer-bias-current-setting value described with reference to Table 1, and may be provided from the second controller 312.

The second switch M2 may be connected to a first node N1 and to a second node N2, and may operate in response to a signal of a second sub-input node INB2 (e.g., the sub-input signal VINB2). The third switch M3 may be connected between the second node N2 and the second power source voltage VSS, and may operate in response to the voltage of the second node N2.

Similarly, the fourth switch M4 may be connected to the first node N1 and to third node N3, and may operate in response to a signal of a second main-input node IN2 (e.g., the main-input signal VIN2). The fifth switch M5 may be connected between the third node N3 and the second power source voltage VSS, and may operate in response to the voltage of the second node N2.

As shown in FIG. 4, first to fourth current values (e.g., 1 uA to 2.5 uA) represent amounts of bias currents flowing in the input buffer 311b corresponding to the buffer-bias-current-setting values of Table 1, respectively.

As the frame frequency increases, the amount of bias current may increase, and response capability (or operation speed) of the input buffer 311b may be improved, and thus the second receiver 311 may receive a distorted signal more effectively.

Referring to FIG. 3, the second controller 312 may receive the compensation control signal CCS from the second receiver 311, and may generate the gain control signal CS_GAIN and the bias control signal CS_BIAS based on the compensation control signal CCS. However, the second controller 312 is not limited thereto. For example, the second controller 312 may receive the data control signal DCS, and may extract the compensation control signal CCS (e.g., the equalizer-gain-setting value and/or the buffer-bias-current-setting value) inserted at a given position in the data control signal DCS to generate the gain control signal CS_GAIN and the bias control signal CS_BIAS.

The second video signal processor 313 may generate a data signal corresponding to the frame data transmitted from the second receiver 311, and the second transmitter 314 may output the data signal to a data line DL connected to the source drive IC 310. For example, the second video signal processor 313 may include a de-serializer for rearranging data to be transmitted serially in parallel, a shift register for sequentially outputting rearranged data, a data latch, and a digital-to-analog converter for converting digital data into an analog data signal. For example, the second transmitter 314 may select and output polarity of the data signal.

As described with reference to FIGS. 3 to 5, while the equalizer 311a compensates for signal distortion of the frame data (e.g., distortion of high-frequency components) in the transmission process from the timing controller 410 to the source drive IC 310, the equalizer 311a may change the gain corresponding to the compensation control signal (or the equalizer-gain-setting value and/or the frame frequency). In addition, while the input buffer 311b removes noises from the frame data, the input buffer 311b may change the bias current in response to the compensation control signal (or the buffer-bias-current-setting value and/or the frame frequency). The power consumption of the equalizer 311a changes according to a change of at least one of the gain of the equalizer 311a and the bias current of the input buffer 311b. The source drive IC 310 may increase the gain and/or the bias current to maintain signal integrity when the frame frequency is high, and may reduce the gain and/or the bias current to reduce power consumption when the frame frequency is low.

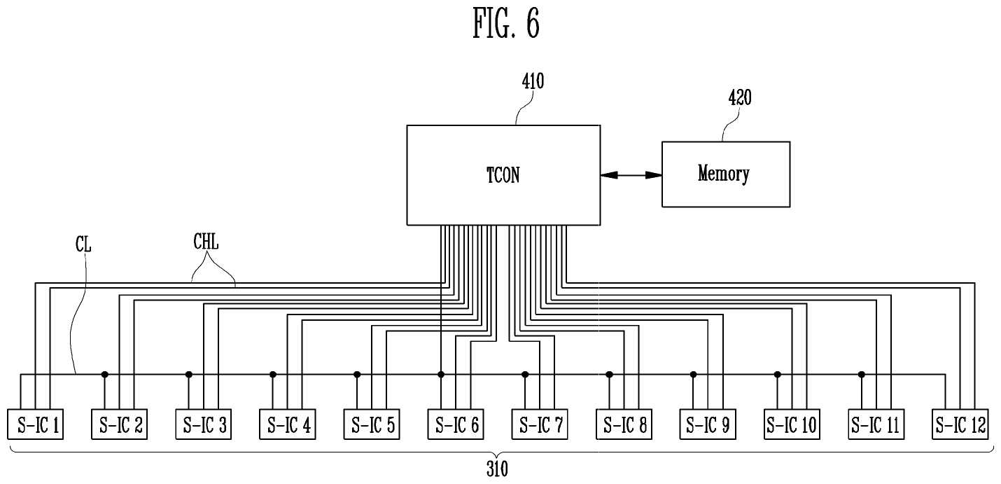

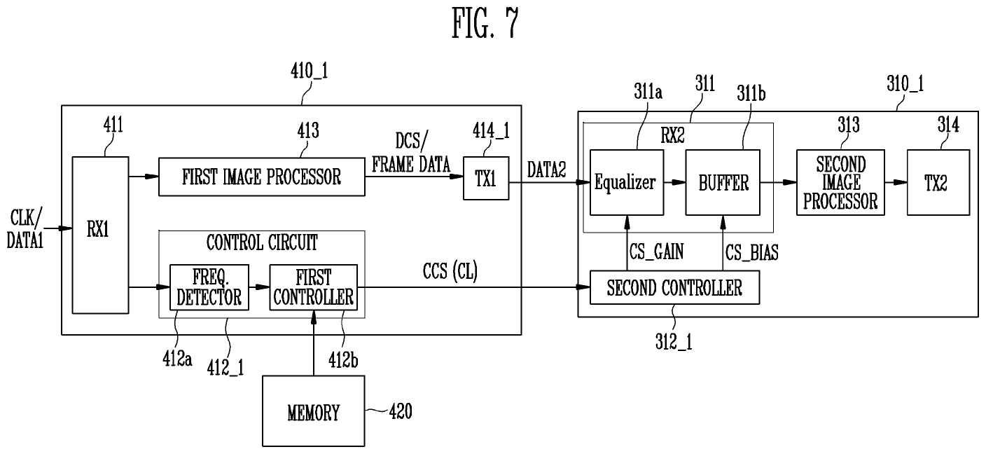

FIG. 6 illustrates another example of a signal transmission line connecting a timing controller and a source drive IC included in a display device of FIG. 1. FIG. 6 also illustrates a signal transmission line corresponding to the signal transmission line shown in FIG. 2. FIG. 7 is a block diagram illustrating another example of a timing controller and a source drive IC included in a display device of FIG. 1. FIG. 7 also illustrates a timing controller 410_1 and a source drive IC 310_1 corresponding to the timing controller 410 and the source drive IC 310 of FIG. 2. Because the timing controller 410_1 and the source drive IC 310_1 are substantially the same as the timing controller 410 and the source drive IC 310 of FIG. 2, except for a common control line CL, duplicate descriptions are omitted.

Referring to FIGS. 1, 2, and 6, a display device 10 (or a signal transmission line described with reference to FIG. 1) may further include a common control line CL.

The common control line CL may be formed between the source drive IC 310 and the timing controller 410. The common control line CL may commonly connect the source drive ICs S-IC 1 to S-IC 12 to the timing controller 410, and may transmit the compensation control signal CCS from the timing controller 410 to the source drive ICs S-IC 1 to S-IC 12. The common control line CL may be implemented as a common bus line.

Referring to FIG. 7, the common control line CL may directly connect a control circuit 412_1 of the timing controller 410_1, and a second controller 312_1 of the source drive IC 310_1 without going through a first transmitter 414_1 of the timing controller 410_1.

The second controller 312 may generate a gain control signal CS_GAIN and a bias control signal CS_BIAS based on the compensation control signal CCS provided from the control circuit 412_1.

As described with reference to FIGS. 6 and 7, the compensation control signal CCS may be transmitted from the timing controller 410 to the source drive ICs S-IC 1 to S-IC 12 in a common and direct manner through a separate common control line CL. Therefore, the source drive ICs S-IC 1 to S-IC 12 may respond more quickly to changes of the frame frequency to maintain signal integrity or to reduce power consumption.

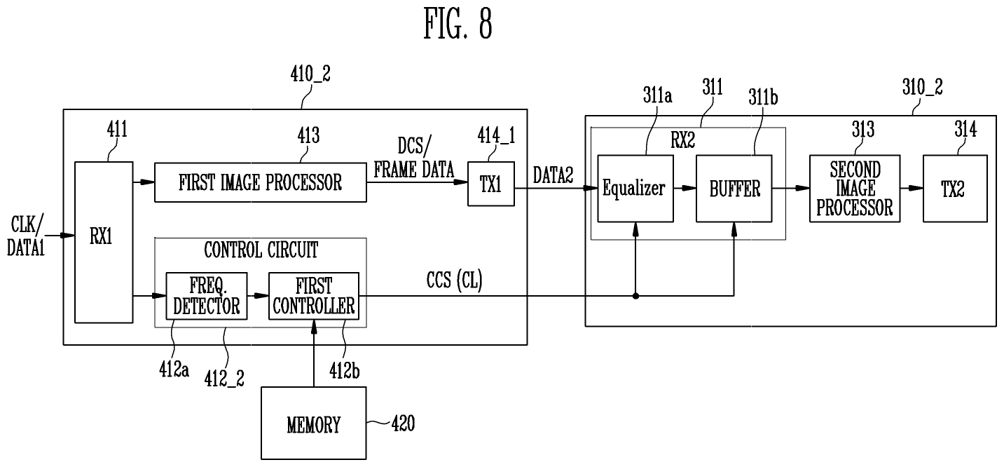

FIG. 8 is a block diagram illustrating another example of a timing controller and a source drive IC included in a display device of FIG. 1. FIG. 8 also illustrates a timing controller 410_2 and a source drive IC 310_2 corresponding to the timing controller 410_1 and the source drive IC 310_1 of FIG. 7, respectively. Because the timing control unit 410_2 and the source drive IC 310_2 are substantially the same as the timing control unit 410_1 and the source drive IC 310_1 of FIG. 7, except for the absence of a second controller 312_1, duplicate descriptions are omitted.

Referring to FIGS. 1, 7, and 8, the common control line CL may directly connect a control circuit 412_1 of the timing controller 410_2 and a second receiver 311 of the source drive IC 310_2. In this case, as shown in FIG. 8, the source drive IC 310_2 may not include the second controller 312_1 (e.g., compare to FIG. 7). A transmission speed of the common control line CL may be different from a transmission speed of the channel line CHL. For example, the common control line CL may have a transmission speed that is lower than the transmission speed of the channel line CHL.

For example, the control circuit 412_1 may directly transmit the compensation control signal CCS to a second receiver 311 of the source drive IC 310_2, and the source drive IC 310_2 may adjust the gain of the equalizer 311a and the bias current of the input buffer 311b in response to the compensation control signal CCS.

For another example, the control circuit 412_1 may generate the compensation control signal CCS including the gain control signal CS_GAIN and the bias control signal CS_BIAS, and may directly transmit the gain control signal CS_GAIN and the bias control signal CS_BIAS to the second receiver 311 of the source drive IC 310_2. The source drive IC 310_2 may adjust the gain of the equalizer 311a in response to the gain control signal CS_GAIN, and may also adjust the bias current of the input buffer 311b in response to the bias control signal CS_BIAS.

Therefore, the source drive ICs S-IC 1 to S-IC 12 may respond more quickly to changes of the frame frequency to maintain signal integrity or to reduce power consumption.

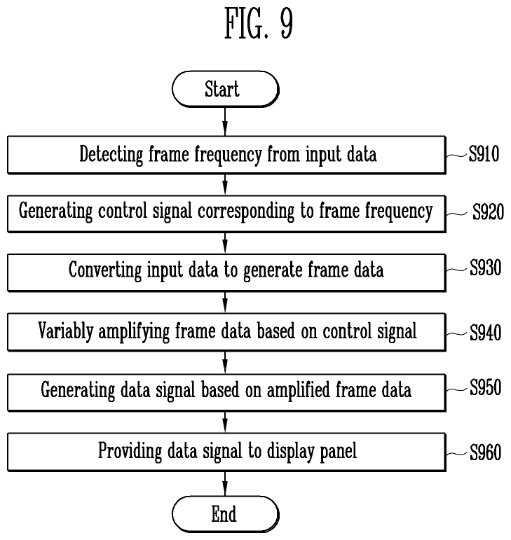

FIG. 9 is a flowchart illustrating a driving method of a display device according to an embodiment of the present disclosure.

Referring to FIGS. 1 and 9, the method of FIG. 9 may be performed in the display device 10 of FIG. 1.

The method of FIG. 9 may detect the frame frequency based on the input data provided to the timing controller 410 (S910), and may generate the control signal (e.g., the data control signal DCS including the compensation control signal CCS) corresponding to the frame frequency (S920).

As described with reference to Table 1, the control signal may include the equalizer-gain-setting value and the buffer-bias-current-setting value. Here, the equalizer-gain-setting value may be a value for controlling the gain of the equalizer 311a included in the second receiver 311 of the source drive IC 310, and the buffer-bias-current-setting value may a value for controlling the bias current used in the input buffer 311b included in the second receiver 311 of the source drive IC 310.

In addition, the method of FIG. 9 may convert the input data to generate the frame data (S930).

The control signal and the frame data may be provided from the timing controller 410 to the source drive IC 310.

The method of FIG. 9 may variably amplify the frame data at a receiving stage of the source drive IC 310 based on the control signal (S940). For example, the method of FIG. 9 may adjust the frequency response characteristic and noise removal capability of the source drive IC 310 based on the control signal of the source drive IC 310.

As described with reference to FIGS. 3 to 6, the method of FIG. 9 may extract the compensation control signal CCS (e.g., the equalizer-gain-setting value and/or the buffer-bias-current-setting value) from the control signal received at the source drive IC 310, may generate the gain control signal CS_GAIN and the bias control signal CS_BIAS, may adjust the gain of the equalizer 311a of the source drive IC 310 based on the gain control signal CS_GAIN, and may also adjust the bias current of the input buffer 311b of the source drive IC 310 based on the bias control signal CS_BIAS.

Next, the method of FIG. 9 my generate the data signal based on the amplified frame data, and (S950), and may provide the data signal to the pixel in the display panel through the data line (S960).

The drawing and the detailed description of the present disclosure referred to above are descriptive sense only and are used for the purpose of illustration only and are not intended to limit the meaning thereof or to limit the scope of the invention described in the claims. Accordingly, a person having ordinary skill in the art will understand from the above that various modifications and other equivalent embodiments are also possible. Therefore, the real protective scope of the present disclosure shall be determined by the technical scope of the accompanying claims, with functional equivalents thereof to be included therein.

What is claimed is:

1. A display device comprising:
a display panel;
a timing controller for detecting a frame frequency of input data, for generating a control signal based on the frame frequency, and for generating frame data by converting the input data; and
a source drive for variably amplifying the frame data based on the control signal, for generating a data signal based on the amplified frame data, and for providing the data signal to the display panel.

2. The display device of claim 1, wherein the source drive comprises:
an equalizer for flattening a frequency response of the frame data;
an input buffer for removing a noise signal from the amplified frame data; and
a video signal processor for generating the data signal based on an output of the input buffer,
wherein the source drive is configured to vary at least one of a gain of the equalizer and a bias current of the input buffer based on the control signal.

3. The display device of claim 2, wherein the source drive further comprises a controller for extracting the control signal from the output of the input buffer, and for generating a gain control signal and a bias control signal based on the control signal,
wherein the equalizer is configured to control the gain in response to the gain control signal, and
wherein the input buffer is configured to adjust the bias current in response to the bias control signal.

4. The display device of claim 2, wherein the gain is configured to increase incrementally as the frame frequency increases.

5. The display device of claim 4, wherein the equalizer comprises:
a main-output node and a sub-output node for outputting the amplified frame data;
a capacitor connected between the main-output node and the sub-output node; and
a resistor connected in parallel with the capacitor,
wherein at least one of capacitance the capacitor and resistance of the resistor varies in response to the control signal.

6. The display device of claim 2, wherein the bias current is configured to increase incrementally as the frame frequency increases.

7. The display device of claim 6, wherein the input buffer comprises:
a first switch that is connected between a first power source voltage and a first node, and is configured to adjust the bias current flowing from the first power source voltage to the first node in response to the control signal;
a second switch that is connected between the first node and a second power source voltage, and that is configured to operate in response to a sub-output signal output from the equalizer; and
a third switch that is connected between the first node and an output terminal, and that is configured to operate in response to a main-output signal output from the equalizer.

8. The display device of claim 1, wherein the timing controller comprises:
a frequency detector for detecting the frame frequency from the input data;
a first controller for generating the control signal by selecting one of setting values based on the frame frequency;
a video signal processor for generating the frame data by rearranging the input data; and
a transmitter for transmitting the control signal and the frame data to the source drive.

9. The display device of claim 8, further comprising a memory device for storing the setting values in a form of a lookup table.

10. The display device of claim 1, further comprising channel lines connecting the timing controller and the source drive,
wherein the control signal and the input data are sequentially provided from the timing controller to the source drive through the channel lines.

11. The display device of claim 1, further comprising channel lines and a common control line connecting the timing controller and the source drive,
wherein the common control line is connected in common with other source drives,
wherein the timing controller is configured to transmit the control signal to the source drive through the common control line, and
wherein the timing controller is configured to transmit the frame data to the source drive through the channel lines.

12. The display device of claim 11, wherein the source drive comprises:
an equalizer for flattening a frequency response of the input data;
an input buffer for removing a noise signal from the amplified frame data;
a video signal processor for generating the data signal based on an output of the input buffer; and
a controller for receiving the control signal directly from the timing controller, and for generating a gain control signal and a bias control signal based on the control signal,
wherein the equalizer is configured to control a gain in response to the gain control signal, and
wherein the input buffer is configured to adjust a bias current of the input buffer in response to the bias control signal.

13. A driving method of a display device comprising:
generating a control signal by detecting a frame frequency of input data in a timing controller;
generating frame data by converting the input data in the timing controller;
variably amplifying the frame data based on the control signal in a source drive; and
generating a data signal based on the amplified frame data to provide the data signal to a display panel.

14. The driving method of claim 13, wherein the variably amplifying the frame data comprises adjusting a frequency response of the frame data by varying a gain of an equalizer in a receiving stage of the source drive in response to the control signal.

15. The driving method of claim 14, wherein the variably amplifying the frame data further comprises adjusting a bias current applied to an input buffer in the receiving stage of the source drive in response to the control signal.
